(19) United States
(12) Patent Application Publication
(10) Pub. No.: US 2017/0334043 A1
(43) Pub. Date: Nov. 23, 2017

(54) Three jaw adjustable socket

(71) Applicant: Thomas Carnesi, Torrance, CA (US)

(72) Inventor: Thomas Carnesi, Torrance, CA (US)

(21) Appl. No.: 15/157,479

(22) Filed: May 18, 2016

(51) Int. Cl. B25B 13/12; B25B 13/44

(52) U.S. Cl. CPC B25B 13/12; B25B 13/44

(57) ABSTRACT

A ⅜ drive adjustable socket apparatus comprised of a three jaw socket members which ride triangularly and radially within an upper cylindrical tapered housing. The jaw members are abutted inward at 15 degrees to the jaw housing radial walls of the same angular taper. Each jaw member has an inner 120 degrees V-notch which becomes a hexagonal configuration when they are trilaterally spaced apart to accept standard hexagonal configured nuts and bolt type fasteners. The adjustable socket apparatus has a ⅜ inch driver end which has a two slotted windows to allow the use of thumb and index finger to rotate the inner serrated wheel that is exposed through both opposite window slots on the bottom portion of the adjustable socket embodiment. The lower driver end of the adjustable socket has a ⅜ square cavity to accept male universal ratcheting driver. The adjustable socket's driver embodiment also has an internal serrated fixed wheel and a right hand threaded central actuator unit which is solidly affixed onto the vertical shaft. When the serrated wheel is manually rotated, it influences the three jaws to either move upwards or downward depending on the axial rotation of the main vertical thread. The three jaws maneuvering is accomplished by a smaller, upper diameter actuator ring horizontally seated at the lower limb of each jaw member to influence its movement in either an upward or downward and tapered motion. The main vertical thread screw is attached to the vertical adjusting wheel which is secured by the horizontal retention snap ring located beneath an internal groove just above the said serrated wheel. As the user rotates the exposed serrated wheel and its vertical threaded vertical internal screw, it will activate the smaller diameter upper horizontal wheel upwards or downwards as the main vertical thread and serrated gear is being manually rotated on its Z axis. This actuates the threaded adjusting horizontal ring which is housed within the three jaw members' lower slotted or pocket features. The upward and or downward, X coordinate rotation will influence the jaw members to move in either an upward or downward motion at a 15 degree inward angle and ride within the tapered cylindrical walls of the upper jaw housing at the same 15 degree angle. Either a clockwise or counterclockwise rotation causes the main central right hand threaded actuator wheel, when rotated, to move the jaws upward and/or downward because of the influence of the main vertical threaded screw.

### CROSS-REFERENCE TO RELATED APPLICATIONS

This application is a continuation-in-part of Ser. No. 11/356,754, filed Feb. 18, 2006 which is now abandoned by the inventor for the instant application?

### BACKGROUND OF THE INVENTION

This utility patent application is for an adjustable socket apparatus having three jaws trilaterally spaced 120 degrees, each jaw having a 120 degrees interior notch feature which becomes a hexagonal configuration to accept hexagon type nuts and bolt fasteners. The adjustable socket apparatus has six main components as follows: three jaw members within the upper jaw housing, a lower driver housing, and a main actuator serrated wheel with affixed main vertical threaded right hand screw which is permanently attached onto the main adjusting serrated thumb wheel. The serrated wheel is retained internally by a standard snap retention C-ring. A smaller actuator wheel is threaded onto the main vertical screw, the thread of which activates the smaller horizontal threaded ring to activate the three jaw members at their lower notches. The manual rotational activation influences the three jaw members to move on an inward/upward or outward/downward path at a 15 degrees angle. The upper and lower main components are threaded and secured as a unit by two fastener dowel pins. Each jaw member has an exterior 30 degrees dovetail projection on the jaw outer surface. This dovetail feature rides and interlocks within the corresponding female dovetail recessed slot feature for additional jaw stability and torque strength for the jaw members.

### Class 81/177 References Cited

### U.S. Patent Documents:

| | | | | |
|---|---|---|---|---|
| 3,724,299 | A * | April 1973 | Nelson | 81/128. |
| 4,213,355 | A * | July 1980 | Colvin | 81/128 |
| 4,378,714 | A * | April 1983 | Colvin | 81/128 |
| 4,663,999 | A * | May 1987 | Colvin | 81/128 |
| 5,207,129 | A * | May 1993 | Fossella | 81/63.2 |
| 5,305,670 | A * | April 1994 | Fossella et al. | 81/63.2 |
| 5,448,931 | A * | September 1995 | Fossella et al. | 81/63.2 |
| 5,819,607 | A * | October 1998 | Carnesi | 81/128 |
| 5,996,446 | A * | December 1999 | Lee | 81/128 |
| 6,073,522 | A * | June 2000 | Carnesi | 81/128 |
| 7,062,996 | B2 * | June 2006 | Johnson | 81/128 |
| 2006/0086211 | A 1 * | April 2006 | Johnson | 81/128 |
| 7,261,021 | A * | August 2007 | Carnesi | 81/128 |

### BACKGROUND OF THE INVENTION

### 1. Field of the Invention

The present invention provides a socket having a first, second and third jaw member that are radially and triangularly located at the top the embodiment to enables the user to adjust the jaws to a selected size in either metric or inch unit to accommodate hexagonal fasteners of various sizes. The user simply rotates the exposed serrated teeth at the lower driver embodiment to rotate in either a clockwise or counterclockwise rotation to adjust the jaw members to either a closing or smaller hex opening or expand the jaws to a larger hex size opening depending on the rotational direction the serrated actuator wheel is being turned.

### 2. Description of the Prior Art

In U.S. Pat. Nos. 5,819,607, 6,073,522 and 7,261,021 B1, there is disclosed a socket which is manually adjustable to enable the socket to grip nuts or bolts with hexagonal configured heads of different sizes. Two opposing jaw members are provided which are adjustably spaced apart to grip a hexagonal bolt head of a selected size. Although the socket allows a user to make the necessary adjustments, it includes numerous components that may add to the cost of manufacturing this adjustable socket tool.

### SUMMARY OF THE INVENTION

1. The object of this invention is to provide an adjustable socket apparatus having a sizeable range from ⅜ to ⅝ inch, and 10 mm to 17 mm to either tighten or loosen hexagonal configured nuts and bolt type fasteners. This new preferred adjustable socket apparatus attaches onto a standard universal ⅜ male driver for tightening and/or loosening standard hex shaped fasteners. This adjustable socket apparatus has a range of twelve hexagonal size openings that range as follows: ⅜ inch, 10 mm, 11 mm, 7/16 inch, 12 mm, ½ inch, 13 mm, 14 mm, 9/16 inch, 15 mm, 16 mm, ⅝ inch and 17 mm. The adjustable socket's lower driver component includes a ⅜ inch square driver cavity to accept standard universal male ratchet drivers. The lower diameter of the lower embodiment has a knurled feature to allow the user to insert and manually align the adjustable socket onto a fastener to be worked. This adjustable socket features three jaws that have a 120 degree internal V-cavity. The jaws are triangularly positioned to each other at 120 degrees, which becomes a hexagonal configuration. The adjustable socket has a lower serrated adjusting wheel that has peripheral serrations exposed through two windows opposite each other. It can be rotated in either a clockwise or counterclockwise rotation to either activate the jaws to move in the upward or downward adjustment at a 15 degree inward or outward taper to close the jaws to a smaller hex opening or open the jaws in the downward path to a larger hex opening. This is accomplished by an internal affixed vertical right hand thread that has an attached horizontal threaded ring disk that seats within the lower slotted pocket of the jaw members. The manual axial rotation of the main serrated wheel that is peripherally threaded, and has a vertical main male thread which influences the horizontal threaded disk to induce the jaws to either move in a tapered and upwards or downwards path at a 15 degrees taper.

### DESCRIPTION OF THE DRAWINGS

For better understanding the present invention and other objects and further features thereof, reference is made to the following description which is to be read and interpreted in conjunction with the accompanying drawings therein:

FIG. 1 is an isometric exploded view of the adjustable socket assembly in a 30 degree view looking downwards at all the components.

FIG. 1a is and isometric exploded view of the adjustable socket assembly in a 30 degree view looking upwards at all the components.

FIG. 2 is a main side view of the adjustable socket embodiment showing the slotted window with exposed serrated thumb adjusting wheel used to vertically adjust the height of the three jaw members.

FIG. 3 is a top view of the adjustable socket embodiment showing the three jaw members.

FIG. 4 is a bottom view of the adjustable socket embodiment showing the square slot driver end.

FIG. 5 is a cut-away section view showing the internal components.

FIG. 6 is an isometric upper view of the adjustable socket assembly.

FIG. 7 is an isometric lower view of the adjustable socket assembly.

FIG. 8 Is an upper ISO view of the jaw member sub-assy. in a closing Z+ axis position.

FIG. 9 Is an upper ISO view of the jaw member sub-assy. in a midway Z− open position.

FIG. 10 Is an upper ISO view of the main adjusting wheel at a counterclockwise rotation showing the main jaw activating serrated wheel in a counterclockwise rotation in a closing position at the Z+ axis.

FIG. 11 Is an upper ISO view of the main adjusting wheel at a counterclockwise rotation showing the main jaw activating serrated wheel in a clockwise rotation in an opening position at the Z− axis.

FIG. 12 Is a close-up of the jaw adjusting serrated thumb/index wheel and partial jaw axis induction wheel located within the jaw's lower pocketed slot.

FIG. 13 Is a side view of the upper jaw housing showing the exterior thread at the lower threaded skirt area.

FIG. 14 Is a front exterior view of the lower driver embodiment showing the slotted window to expose the serrated adjusting wheel.

FIG. 15 Is an Isometric view looking down at approximately 45 deg. of the lower driver half embodiment with a snap ring installed to retain the main serrated actuator wheel.

FIG. 16 Is a cross section view B-B of the upper jaw housing showing the internal bore features for the jaws, internal dove-tail V-notch and assembly thread.

FIG. 17 Is a cross section view A-A of the lower driver housing showing the internal bore, internal thread, adjusting wheel window slots, assembly hole and ⅜ square driver cavity.

FIG. 18 Is a top view of the upper jaw housing showing the jaw cavities where the jaw members ride at a 10 degree angular taper inwardly and, also the dove tail slot where said jaw members are guided at the 10 degree taper.

FIG. 19 Is a bottom view of the upper jaw housing showing the jaw members abutting walls and dove tail V-slots and counter bore.

FIG. 20 Is the top view showing one of three jaw members, the actuator vertical Z axis and the threaded jaw adjusting ring with threaded main vertical axis thread screw and the lower main serrated actuator wheel.

FIG. 21 Is a side view of the main adjusting actuator wheel with the threaded vertical axis jaw actuator with the actuator ring engaged into one of three jaw members at the Z+ axis when the jaw is in a smaller opening induced by the adjusting threaded axial ring CCW rotation.

FIG. 22 Is a side view of the main adjusting actuator wheel with the threaded vertical axis jaw actuator with the actuator ring engaged into one of three jaw members at the Z− axis when the jaw is in a larger opening induced by the adjusting threaded axial ring CW rotation.

FIG. 23 Is section view showing one of three jaw members, main serrated actuator wheel, main vertical right-hand threaded screw and actuator jaw ring at approximately mid jaw opening position when the main actuator wheel is being rotated in a clockwise rotation.

FIG. 23a Is a close-up of the serrated peripheral teeth on the adjusting wheel for the jaw member.

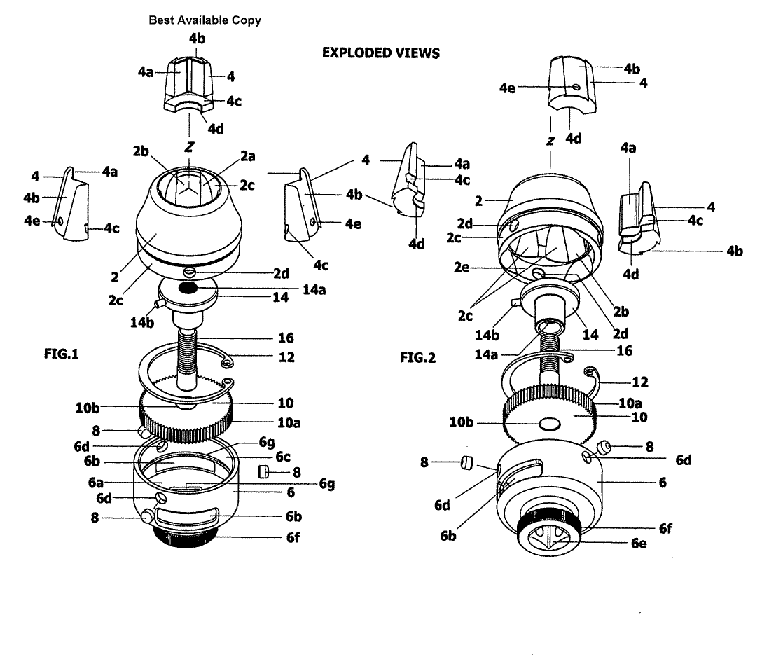

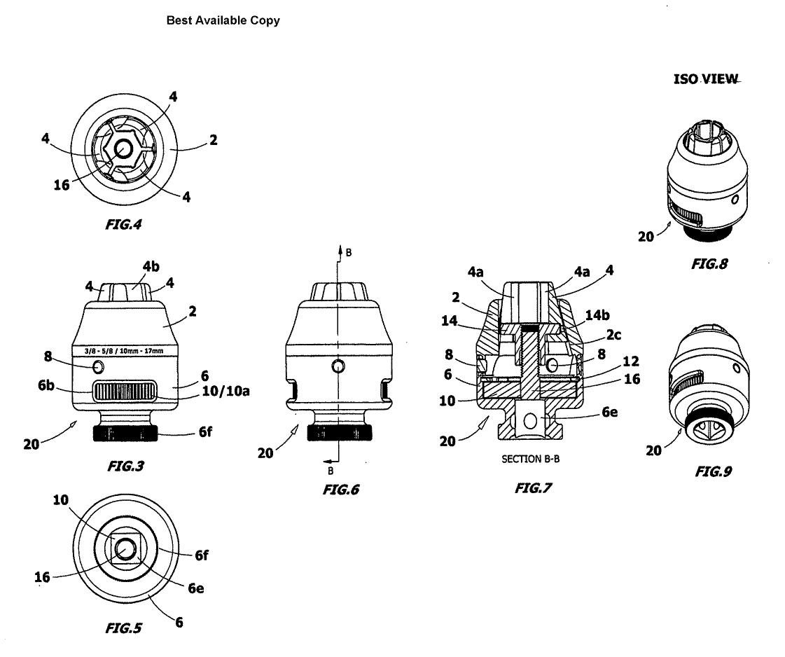

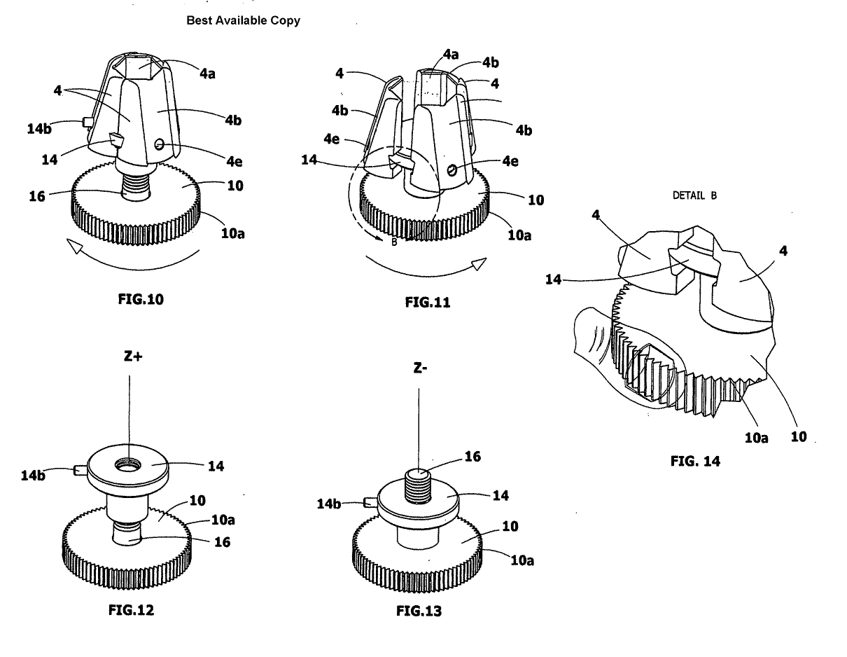

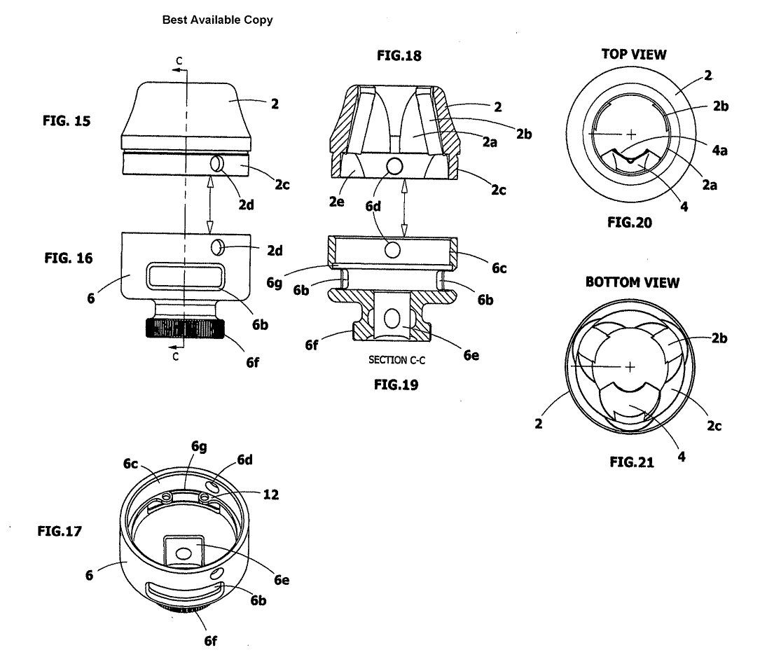

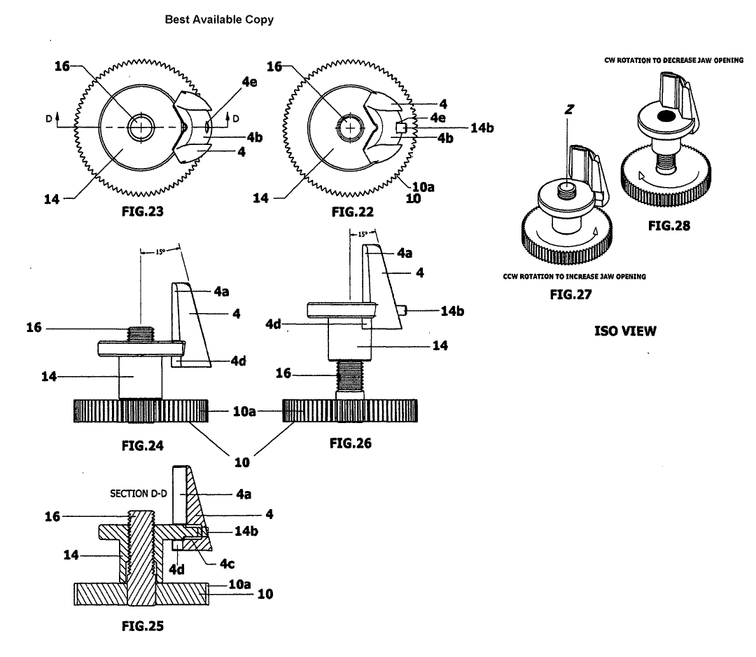

### A DETAILED DESCRIPTION OF THE INVENTION

Referring to Figures, the adjustable socket 20 of the present invention comprises an external upper cylindrical driver housing 2 that has three radially spaced 15 degree inwardly tapered radius configured walls 2a that have a V-notch slot 2b within the center of the radius walls 2a, and centrally positioned to the Z axis which accepts three jaw members 4 having an internal 120 degree cavity 4a to form a trilateral hexagonal configuration for hex fasteners of various sizes, a male V-notch node 4b that is compatible, and rides within and is secured at the V-notch cavities 2b on the radius walls 2a of the jaw cylinder housing 2, the adjustable socket apparatus 20 of this invention which includes a lower driver embodiment 6, a right hand internally formed thread 6b that mates with the upper cylinder 2 external threaded skirt 2c and is firmly retained by two opposing dowel pins 8, the lower driver housing 6 has a serrated ratcheting gear 10. The gear 10 is seated axially within the lower driver embodiment 6a and is retained by a C-ring 12 that is retained within an internal groove 6c, end-to-end slotted windows 6d and is secured by a snap ring 12. The serrated actuator wheel 10 is rotatable about its Z axis that includes serrated teeth 10a about its periphery of serrated gear 10 has a vertical actuator screw 10b. The serrated teeth 10a are for thumb index finger manual rotation through two opposite slotted windows 6d located on the lower driver embodiment 6, a central vertical main actuating screw 10b with mating actuator internal threaded ring 14 and internal thread 14a. The jaw adjusting ring 14 seats within the jaws 4 lower actuator slot 4c to activate said jaw members to move upwards or downwards at a 15 degree taper. The lower driver member features a ⅜ square cavity 10e to accept a standard universal male driver ratchet. The lower knurl feature 6d of the lower driver embodiment 6 of the adjustable socket 20 is for a user to hand adjusts the socket jaws to a specific hexagonal size.

### SCOPE OF THE INVENTION

The above represents the best descriptive mode contemplated in carrying out this invention, the manner and process of its manufacture, its utilization in such full, clear and concise terms as to enable any person skilled in the art to which it pertains to effectively produce and use this invention. This invention is, however, susceptible to modifications and alternate constructions thereof from that discussed above which are fully equivalent. Consequently, it is not the intention to limit this invention to the particular embodiment disclosed. On the contrary, the intent is to cover all modifications and alternate constructions coming within the spirit and scope of the invention as generally expressed by the following claims, which particularly point out and distinctly claim the subject matter of this invention.

I claim:

1. A three jaw adjustable socket with a number of adjustable socket size openings to accommodate different size hexagonal fasteners, a fixed and a lower drive member with an interior serrated wheel with exterior teeth that are exposed through two opposite slotted windows on the lower adjustable socket driver embodiment. The exposed teeth through two slotted windows 180 degrees apart are provided at the lower driver embodiment of the adjustable socket apparatus are for thumb and index finger axial rotation. This manual rotation activates the three jaw members that taper together by axial rotation to smaller hex opening adjustments, as the serrated wheel is being manually rotated in a counterclockwise rotation. This downward rotation movement expands the jaw members to larger hexagonal openings. The upper jaw housing and the lower driver housing is an exterior unit. The upper jaws cylindrical housing retains the three trilateral jaw members that that are positioned 120 degree triangularly and move axially and on a 10 degree taper upwards to a smaller hexagonal size as the three jaws come together. When the user rotates the serrated gear in the opposite rotation of the serrated exposed wheel, the three jaw members' axial movement is expanded downward at 15 degree to a larger hex opening on the Z axis plane and is influenced by a horizontal cylindrical threaded disc that is threaded onto a vertical main threaded helix screw. The threaded disc is nestled within the lower jaws pocket, and the threaded disc driver unit is manually rotatable to a clockwise or counterclockwise rotation depending on the desired jaw openings.

2. Each jaw member has an exterior 30 degree included dovetail projection on the jaw outer surface. This dovetail feature rides and interlocks within the corresponding female dovetail recessed slot feature on the upper cylindrical jaw housing for additional jaw stability and torque strength for each of the jaw member. The main actuator serrated wheel with affixed main vertical threaded right hand screw is permanently attached onto the main adjusting serrated thumb wheel. It is retained internally by a standard snap retention C-ring. A smaller horizontal actuator wheel ring is threaded onto the main vertical screw which activates the three jaw members at their lower notch. The manual rotational activation influences the three jaw members to move inward or downward at a 15 degree angle. The upper and lower main components are threaded and secured by two fastener dowel pins. Each jaw member has an exterior 30 degrees dovetail projection on the jaw outer surface. This dovetail feature rides and interlocks within the corresponding female dovetail recessed slot feature on the upper cylindrical jaw housing for additional jaw stability and torque strength to each of the jaw members.
